(19) United States
(12) Patent Application Publication
(10) Pub. No.: US 2021/0173784 A1
(43) Pub. Date: Jun. 10, 2021

(54) MEMORY CONTROL METHOD AND SYSTEM

(71) Applicant: Alibaba Group Holding Limited, Grand Cayman (KY)

(72) Inventors: Dimin Niu, Sunnyvale, CA (US); Lide Duan, Sunnyvale, CA (US); Hongzhong Zheng, Sunnyvale, CA (US)

(21) Appl. No.: 16/706,427

(22) Filed: Dec. 6, 2019

(51) Int. Cl. G06F 12/0868; G06F 12/02; G06F 9/46; G06F 11/10; G06F 13/16

(52) U.S. Cl. CPC G06F 12/0868; G06F 12/0246; G06F 9/467; G06F 2212/7207; G06F 11/1044; G06F 13/1668; G06F 11/102

(57) ABSTRACT

Memory control methods and systems are provided. A memory architecture includes one or more accelerators, a controller, and a transactional interface. A respective accelerator of the one or more accelerators includes a respective storage area configured to store data and a respective computation unit configured to perform computation. The respective storage area and the respective computation unit are configured to interact with each other. The controller is coupled with the one or more accelerators. The controller is configured to control the one or more accelerators, receive a command from a host, and perform an operation in response to receiving the command. The transactional interface is coupled between the controller and the host and includes a command and address signal channel, which is configured to transfer command and address signals from the host to the controller.

### BACKGROUND

In the area of memory technology, designers and producers are concerned with improving memory architecture in terms of speed, capacity, cost, power efficiency, control efficiency, etc. Accordingly, interfaces of memory are developed and upgraded to facilitate the improvement of memory architectures. Conventionally, the dual in-line memory module (DIMM) includes a series of dynamic random-access memory (DRAM) chips. The host may control the DRAM chips in the memory module over the memory interface, which includes multiple channels. However, when the memory module works as a slave device, there is no feedback signal sent from the memory module to the host. Thus, when the host performs various operations on the memory module, the host does not have any information regarding whether the operation is successful and when the operation is completed. Therefore, there is a need to improve memory control over the memory interface such that the communication between the host and memory can be conducted with accuracy and flexibility.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1A illustrates an example communication schematic of a memory system and a host.

FIG. 1B illustrates an example communication schematic of a memory system and a host.

FIG. 2 illustrates an example communication schematic of a memory system and a host.

FIG. 3 illustrates an example communication schematic of a memory system and a host.

FIG. 4 illustrates an example communication schematic of a memory system and a host.

FIG. 5 illustrates an example diagram of communications between a host and a memory system.

FIG. 6A illustrates an example diagram of communications between a host and a memory system.

FIG. 6B illustrates an example diagram of communications between a host and a memory system.

FIG. 7 illustrates an example diagram of communications between a host and a memory system in an out-of-order (OoO) manner.

FIGS. 8A and 8B illustrate an example process of memory control.

FIG. 9 illustrates an example process of memory control.

FIG. 10 illustrates an example table comparing characteristics of a conventional DDR interface based memory architecture and a transactional interface based memory architecture.

### DETAILED DESCRIPTION

Systems and methods discussed herein are directed to improving memory control, and more specifically, to improving memory control methods and systems.

Conventionally, the speed of memory has not kept up with the speed of the Central Processing Unit (CPU). The data movement from memory is more expensive in terms of bandwidth, energy, and latency than computation. The growing disparity between CPU and memory is referred to as the “memory wall.”

Some accelerator architectures are designed to provide powerful computing capability and large memory capacity/bandwidth to address the memory wall crisis. Examples of accelerator architectures may include, but are not limited to, Intelligent Random Access Memory (IRAM), DRAM-based Reconfigurable In-Situ Accelerator (DRISA), Processing-in-memory (PIM) architecture, etc. The PIM architecture is a memory architecture through which computations and processing can be performed within a computing device's memory.

The PIM architecture is rapidly rising as an attractive solution to the memory wall issue. With the PIM architecture, certain kinds of algorithms would be processed by data processing units (DPUs) inside the memory. Although researchers have studied the PIM concept for decades, the attempts to implement PIM architecture encountered difficulties due to practicality concerns. For example, the designer of PIM architecture cannot achieve the same high memory capacity on a single chip as on multiple chips. With traditional memory arrays, the memory chip-to-memory chip communications can become the primary bottleneck. Also, PIM may have an inferior position in the memory market. For example, 128 MB memory from different manufacturers may not be interchangeable, which could hurt interoperability and drive prices up.

The practicality problems are alleviated with advances in emerging memory technologies in recent years. For example, an approach is to have DPUs integrated inside the DRAM. The distances between the DPUs and the memory cells in the DRAM are short, and the energy to move data back and forth is small, and the latencies are significantly low, meaning that computations can be performed within the memory quickly, which also frees up the CPU to do other kinds of complicated work. In other words, the PIM architecture can accelerate computation and reduce the overhead of data movement.

Emerging data-intensive workloads/applications can no longer be practically handled by traditional computers, which often subject to the Von Neumann bottleneck. The idea of Von Neumann bottleneck is that the computer system throughput is limited due to the relative ability of processors compared to top rates of data transfer. A processor is idle for a certain amount of time while memory is accessed. However, the new generation of data-intensive workloads/applications such as machine-learning tasks can benefit from the PIM technology. PIM acceleration solution localizes processing cores next to the data, solving the bottleneck of Big Data computing. Reportedly, PIM solutions can accelerate data-intensive workloads/applications 20 times, with almost zero extra energy surcharge. The developing PIM solution opens new horizons for the Big Data era, in terms of performance and cost-efficiency.

However, it is still challenging to integrate PIM architecture with conventional computing systems in a seamless manner because PIM architecture requires unconventional control techniques. Many of the current approaches do not address how to implement various control of PIM adequately.

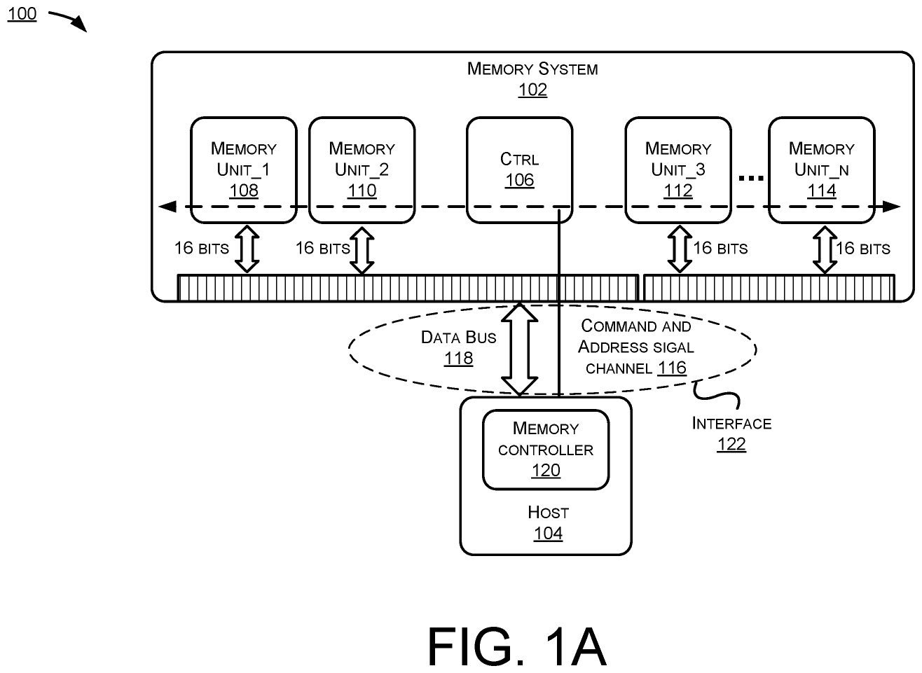

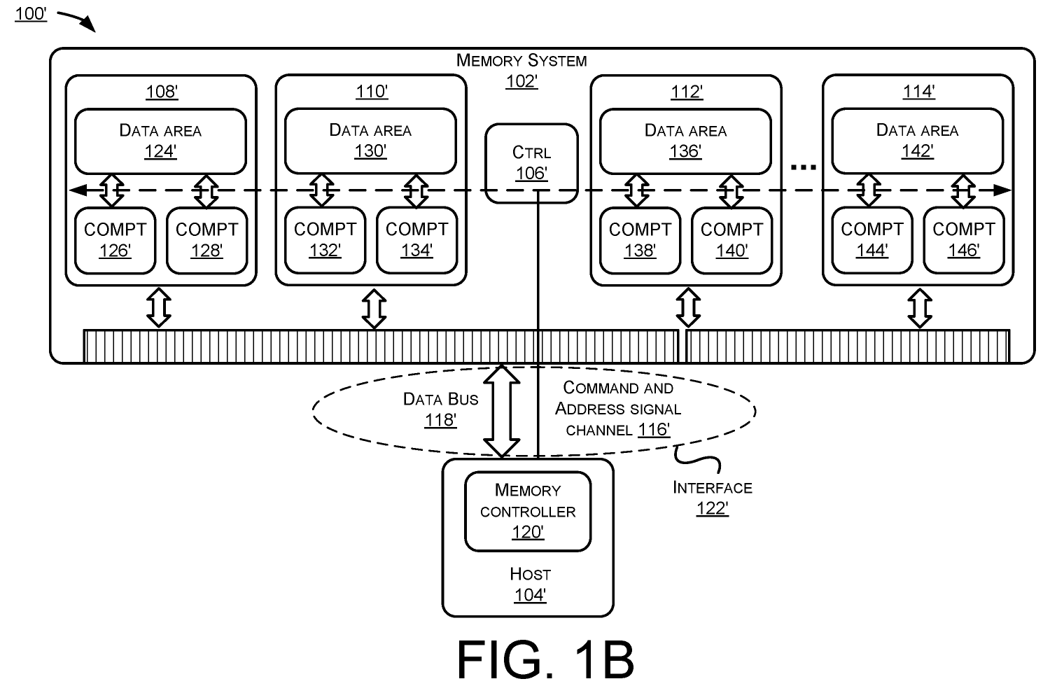

FIG. 1A illustrates an example communication schematic 100 of a memory system 102 and a host 104. In implementations, the memory system 102 may be any suitable type of memory architectures such as a DDR based architecture and so on. In implementations, the memory system 102 may include volatile memory, such as SRAM, DRAM, and the like, and non-volatile, such as flash memory, Phase Change Memory, Spin-transfer torque magnetic random-access memory (STT-RAM), resistive random-access memory (ReRAM), and the like, or any combination thereof. In implementations, the host 104 may include, but is not limited to, a CPU, an Application-Specific Integrated Circuit (ASIC), a Graphics Processing Unit (GPU), Field Programmable Gate Arrays (FPGAs), a Digital Signal Processor (DSP), or any combination thereof.

Referring to FIG. 1A, the memory system 102 may include a controller 106, and n memory units including memory unit_1 108, memory unit_2 110, memory unit_3 112, . . . , and memory unit_n 114. By way of example but not limitation, the total number n of memory units in the memory system 102 is a power of 2.

The controller 106 is configured to receive command and address signals from the host 104 via the command and address signal channel/lines 116. The controller 106 is further configured to control a respective memory unit of memory unit_1 108, memory unit_2 110, memory unit_3 112, . . . , and memory unit_n 114.

The respective memory unit of memory unit_1 108, memory unit_2 110, memory unit_3 112, . . . , and memory unit_n 114 is configured to transfer data/signals via the data bus 118 to/from the host 104. In implementations, the respective memory unit of memory unit_1 108, memory unit_2 110, memory unit_3 112, . . . , and memory unit_n 114 may be a “×4” (“by four”), “×8” (“by eight”), “×16” (“by sixteen”), etc. memory chip, where “×4”, “×8”, and “×16” refer to the data width of the chip in bits. In implementations, memory unit_1 108, memory unit_2 110, memory unit_3 112, . . . , and memory unit_n 114 are configured to transfer data/signals at any suitable data width, for example, 16 bits. In implementations, the respective memory unit of memory unit_1 108, memory unit_2 110, memory unit_3 112, . . . , and memory unit_n 114 may be configured with the accelerator architecture.

The host 104 includes a memory controller 116. The host 104 is configured to exchange data/signals with the memory system 102 using the memory controller 116 via the data bus 118. In implementations, the data width of the data bus may be any suitable width, for example, 64 bits. The host 104 is further configured to send the command and address signals to the controller 106 of the memory system 102 using the memory controller 116 via the command and address signal channel/lines 116.

Collectively, the command and address signal channel/lines 116 and the data bus 118 may be referred to as interface 122. In other words, the interface 122 may include the command and address signal channel/lines 116 and the data bus 118. The interface 122 is coupled between the host 104 and the memory system 102. In implementations, the interface 122 may be any suitable memory interfaces, for example, a DDR interface. In implementations, the interface 122 may further include other lines/channels such as clock lines, control signal lines, and the like.

FIG. 1B illustrates an example communication schematic 100′ of a memory system 102′ and a host 104′. In implementations, the memory system 102′ may be any suitable type of memory architectures such as a DDR based architecture and so on. In implementations, the memory system 102′ may include volatile memory, such as SRAM, DRAM, and the like, and non-volatile, such as flash memory, Phase Change Memory, STT-RAM, ReRAM, and the like, or any combination thereof. In implementations, the host 104′ may include, but is not limited to, a CPU, an ASIC, a GPU, FPGAs, a DSP, or any combination thereof.

Referring to FIG. 1B, the memory system 102′ may include a controller 106′, and n memory units including memory unit_1′ 108′, memory unit_2′ 110′, memory unit_3′ 112′, . . . , and memory unit_n 114′. By way of example but not limitation, the total number n of memory units in the memory system 102′ is a power of 2.

The controller 106′ is configured to receive command and address signals from the host 104′ via the command and address signal channel/lines 116′. The controller 106′ is further configured to control a respective memory unit of memory unit_1′ 108′, memory unit_2′ 110′, memory unit_3′ 112′, . . . , and memory unit_n 114′.

The respective memory unit of memory unit_1′ 108′, memory unit_2′ 110′, memory unit_3′ 112′, . . . , and memory unit_n 114′ is configured to transfer data/signals via the data bus 118′ to/from the host 104′. In implementations, the respective memory unit of memory unit_1′ 108′, memory unit_2′ 110′, memory unit_3′ 112′, . . . , and memory unit_n 114′ may be a “×4′” (“by four”), “×8′” (“by eight”), “×16′” (“by sixteen”), etc. memory chip, where “×4′”, “×8′”, and “×16′” refer to the data width of the chip in bits. In implementations, memory unit_1′ 108′, memory unit_2′ 110′, memory unit_3′ 112′, . . . , and memory unit_n 114′ are configured to transfer data/signals at any suitable data width, for example, 16′ bits.

The host 104′ includes a memory controller 116′. The host 104′ is configured to exchange data/signals with the memory system 102′ using the memory controller 116′ via the data bus 118′. In implementations, the data width of the data bus may be any suitable width, for example, 64′ bits. The host 104′ is further configured to send the command and address signals to the controller 106′ of the memory system 102′ using the memory controller 116′ via the command and address signal channel/lines 116′.

Collectively, the command and address signal channel/lines 116′ and the data bus 118′ may be referred to as interface 122′. In other words, the interface 122′ may include the command and address signal channel/lines 116′ and the data bus 118′. The interface 122′ is coupled between the host 104′ and the memory system 102′. In implementations, the interface 122′ may further include other lines/channels such as clock lines, control signal lines, and the like.

In implementations, the respective memory unit of memory unit_1′ 108′, memory unit_2′ 110′, memory unit_3′ 112′, . . . , and memory unit_n 114′ may be configured with the accelerator architecture, for example, the PIM architecture. In implementations, the memory unit_1′ 108′ may include a data area 124′ configured to store data, a computation block (COMPT in short) 126′ configured to store data, and a computation block 128′ configured to perform computation. The data area 124′ is further configured to communicate/interact with the computation block 126′ and the computation block 128′. The memory unit_2′ 110′ may include a data area 130′ configured to store data, a computation block 132′ configured to store data, and a computation block 134′ configured to perform computation. The data area 130′ is further configured to communicate/interact with the computation block 132′ and the computation block 134′. The memory unit_3′ 112′ may include a data area 136′ configured to store data, a computation block 138′ configured to store data, and a computation block 140′ configured to perform computation. The data area 136′ is further configured to communicate/interact with the computation block 138′ and the computation block 140′. The memory unit_n 114′ may include a data area 142′ configured to store data, a computation block 144′ configured to store data, and a computation block 146′ configured to perform computation. The data area 142′ is further configured to communicate/interact with the computation block 144′ and the computation block 146′. Though FIG. 1B shows that the respective memory unit includes one data area and two computation blocks, the present disclosure is not limited thereto, and the respective memory unit may include other numbers of data areas and computation blocks. With the PIM architecture, certain kinds of algorithms would be processed by the computation blocks inside the memory units, thereby eliminating some of the costly data movement between the memory system 102′ and the host 104′ and massively improving the overall efficiency of computation. In other words, the PIM architecture can accelerate computation and reduce the overhead of data movement.

However, when the memory system 102/102′ is working as a slave device, there is no feedback signal sent from the memory system 102/102′ to the host 104/104′. Thus, when the host 104/104′ performs various operations on the memory, the host 104/104′ does not have any information regarding whether the operation is successful and when the operation is completed. Thus, there is a need to improve the memory control such that the communication between the host and memory can be conducted with accuracy and flexibility. In other words, the memory control is improved.

Joint Electron Device Engineering Council (JEDEC) promulgates a Non-Volatile Dual In-Line Memory Module-P (NVDIMM-P) protocol. According to the protocol, the double data rate (DDR) DRAM interface is modified to be an emerging transactional memory interface to communicate with a host. The emerging transactional memory interface may be extended to support various memory media like Non-Volatile Memory (NVM), Flash, managed DRAM, etc.

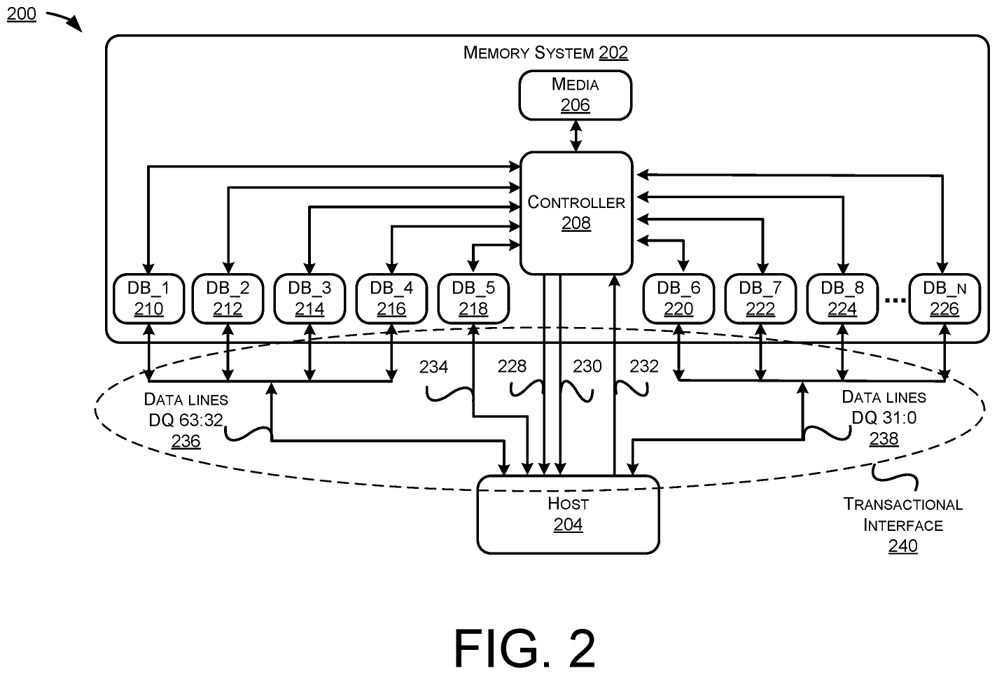

FIG. 2 illustrates an example communication schematic 200 of a memory system 202 and a host 204. In implementations, the memory system 202 may be any suitable type of memory architectures such as DDR based architecture, NVDIMM based architecture and the like. In implementations, the memory system 202 may include volatile memory, such as SRAM, DRAM, and the like, and non-volatile, such as flash memory, Phase Change Memory, STT-RAM, ReRAM, and the like, or any combination thereof. In implementations, the host 204 may include, but is not limited to, a CPU, an ASIC, a GPU, FPGAs, a DSP, or any combination thereof.

Referring to FIG. 2, the memory system 202 may include media 204, a controller 208, and n data buffers (DBs) including DB_1 210, DB_2 212, DB_3 214, DB_4 216, DB_5 218, DB_6 220, DB_7 222, DB_8 224, . . . , and DB_n 226. By way of example but not limitation, the total number n of data buffers in the memory system 202 is a power of 2.

The media 204 is configured to communicate with the controller 208. In implementations, the media 204 may include, but are not limited to, volatile memory, such as SRAM, DRAM, and the like, and non-volatile, such as flash memory, Phase Change Memory, STT-RAM, ReRAM, and the like, or any combination thereof.

The controller 208 is configured to communicate with and control the data buffers including DB_1 210, DB_2 212, DB_3 214, DB_4 216, DB_5 218, DB_6 220, DB_7 222, DB_8 224, . . . , and DB_n 226 to transfer data/signals to/from the data buffers. The controller 208 is further configured to send response/confirmation signals to the host 204 via a first response signal channel/line RESPONSE_A 228 and a second response signal channel/line RESPONSE_B 230.

The controller 208 is further configured to receive command and address signals from the host 204 via a command and address signal channel/line 232.

A respective data buffer of DB_1 210, DB_2 212, DB_3 214, DB_4 216, DB_6 220, DB_5 218, DB_7 222, DB_8 224, . . . , and DB_n 226 is configured to maintain the signal integrity and deliver high performance input/output (I/O) while the data/signals are moving between the host 204 and the memory system 202 via a data bus. The respective data buffer of DB_1 210, DB_2 212, DB_3 214, DB_4 216, DB_6 220, DB_5 218, DB_7 222, DB_8 224, . . . , and DB_n 226 is further configured to communicate with the controller 208 to transfer data/signals. As an example, the data buffer DB_5 218 is further configured to communicate with the host via check bit channel/lines CB7:0 234. Additionally or alternatively, other data buffers may be configured to communicate with the host via check bit channel/lines CB7:0 234.

In implementations, the data width of the data bus may be any suitable width, for example, 64 bits and the like. The data bus may include 64 data lines DQ0, DQ1, DQ2, . . . , DQ63. As an example, data lines DQ63:32 236 may be configured to transfer data/signals to/from data buffers DB_1 210, DB_2 212, DB_3 214, and DB_4 216 from/to the host 204. Data lines DQ31:0 may be configured to transfer data/signals to/from data buffers DB_6 220, DB_7 222, DB_8 224, . . . , and DB_n 226 from/to the host 204.

Check bit channel/lines CB7:0 234 may be configured to transfer data/signals to/from the data buffer DB_5 218 from/to the host 204. In implementations, the memory system 202 may work in an Error-Correcting Code (ECC) mode, in which the memory system 202 can detect and/or correct common kinds of internal data corruption. The check bit channel/lines CB7:0 234 may be configured to transfer ECC signals to/from the data buffer DB_5 218 from/to the host 204. Additionally or alternatively, the memory system 202 may work in a non-ECC mode or partial-ECC (customized, non-JEDEC standard compatible ECC algorithms with less ECC bits required).

The check bit channel/lines CB7:0 234 may be further configured to transfer metadata to/from the data buffer DB_5 218 from/to the host 204. The metadata may include, but is not limited to, information regarding the type of data, a protection level of data, a priority level of data, a persistency requirement of data, customized ECC data, etc. The protection level of data, the priority level of data, the persistency requirement of data, and the customized ECC data may be configured and/or adjusted dynamically. The metadata may be used by the controller 208 to direct the data into different media. For example, the persistency requirement of data in the metadata indicates the data need to be saved permanently, and thus the controller 208 saves the data in persistent memory such as Phase Change Memory, STT-RAM, ReRAM, and the like according to the metadata. For example, the persistency requirement of data in the metadata indicates the data do not need to be saved permanently, and thus the controller 208 saves the data in volatile memory such as SRAM, DRAM, and the like according to the metadata. For example, the protection level of data in the metadata is relatively high, and thus the controller 208 saves the data with multiple copies. For example, the customized ECC data may include ECC data customized by a user.

The command and address signal channel/line 232 is configured to transfer the command and address signals from the host 204 to the controller 208.

The first and second response signal channel/lines RESPONSE_A 228 and RESPONSE_B 230 are configured to transfer the response/confirmation signals from the controller 208 to the host 204. In implementations, the first response signal channel/line RESPONSE_A 228 may be configured to transfer an error signal from the controller 208 to the host 204. Additionally or alternatively, these two response signal channel/lines RESPONSE_A 228 and RESPONSE_B 230 may be integrated into one channel/line.

Collectively, the data bus (including data lines DQ 0:63), the check bit channel/lines CB7:0 234, the command and address signal channel/line 232, the first and second response signal channel/lines RESPONSE_A 228 and RESPONSE_B 230, may be referred to as transactional interface 240. In other words, the transactional interface 240 may include the data bus (including data lines DQ 0:63), the check bit channel/lines CB7:0 234, the command and address signal channel/line 232, the first and second response signal channel/lines RESPONSE_A 228 and RESPONSE_B 230. The transactional interface 240 is coupled between the host 204 and the memory system 202. In implementations, the transactional interface 240 may further include other lines/channels such as clock lines, control signal lines, and the like.

With the above example communication schematic 200, response/confirmation signals may be sent from the memory system 202 to the host 204. Thus, when the host 204 performs various operations on the memory system 202, the host 204 may have information regarding whether the operation is successful and when the operation is completed, which is described in detail hereinafter. Therefore, the communication between the host 204 and the memory system 202 can be conducted with accuracy and flexibility. In other words, the memory control is improved.

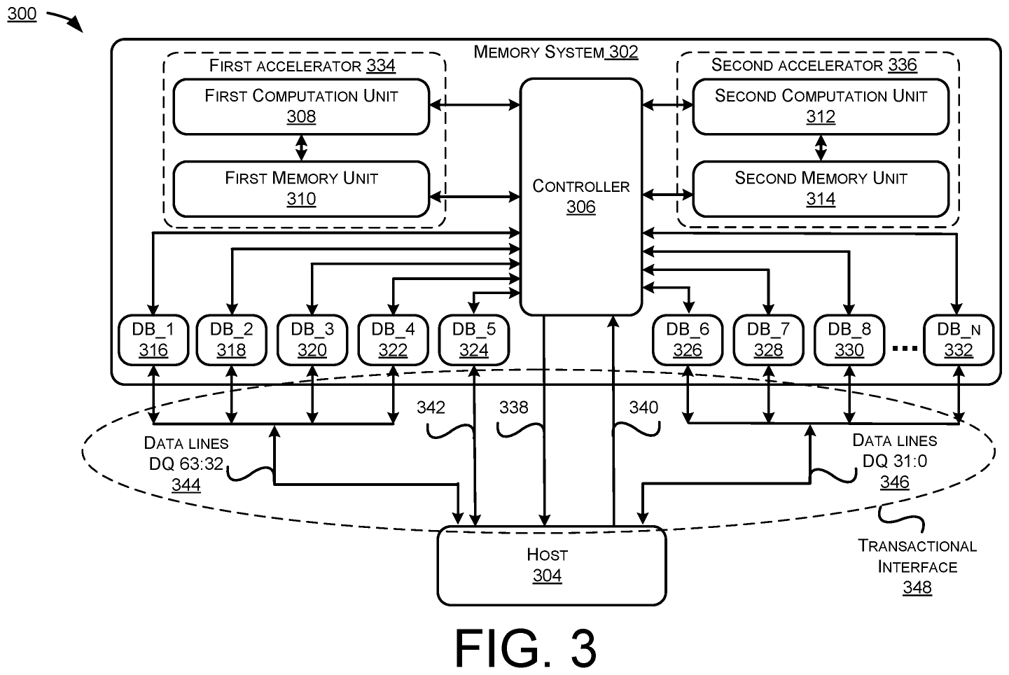

FIG. 3 illustrates an example communication schematic 300 of a memory system 302 and a host 304. In implementations, the memory system 302 may be any suitable type of memory architectures such as DDR based architecture, NVDIMM based architecture, and the like. In implementations, the memory system 302 may include volatile memory, such as SRAM, DRAM, and the like, and non-volatile, such as flash memory, Phase Change Memory, STT-RAM, ReRAM, and the like, or any combination thereof. In implementations, the host 304 may include, but is not limited to, a CPU, an ASIC, a GPU, FPGAs, a DSP, or any combination thereof.

Referring to FIG. 3, the memory system 302 may include a controller 306, a first computation unit 308, a first memory unit 310, a second computation unit 312, a second memory unit 314, and n data buffers including DB_1 316, DB_2 318, DB_3 320, DB_4 322, DB_5 324, DB_6 326, DB_7 328, DB_8 330, . . . , DB_n 332. By way of example but not limitation, the total number n of data buffers is a power of 2. The dashed line box 334 represents that the first computation unit 308 and the first memory unit 310 may be referred to as a first accelerator 334. The dashed line box 336 represents that the second computation unit 312 and the second memory unit 314 may be referred to as a second accelerator 336. With the accelerator architecture, some computation can be processed by the computation units inside the memory system 302, thereby eliminating some of the costly data movement between the host 304 and the memory system 302 and massively improving the overall efficiency of computation blocks.

Though FIG. 3 shows two computation units and two memory units, the present disclosure is not limited thereto, and the memory system 302 may include other numbers of computation units and memory units. In implementations, the first memory unit 310 and the second memory unit 314 may also be referred to as storage areas. In implementations, the number of computation units may be the same as the number of memory units. In implementations, the number of data buffers is not necessarily the same as the number of computation units or the number of memory units. Though FIG. 3 shows that the memory system 302 includes two accelerators 334 and 336, the present disclosure is not limited thereto. Other numbers of accelerators may be included in the memory system 302.

The controller 306 is configured to communicate with and control the first computation unit 308, the first memory unit 310, the second computation unit 312, and the second memory unit 314. The controller 306 is further configured to communicate with and control a respective data buffer of DB_1 316, DB_2 318, DB_3 320, DB_4 322, DB_5 324, DB_6 326, DB_7 328, DB_8 330, . . . , DB_n 332 to transfer data/signals to/from the data buffers.

The controller 306 is further configured to send a response/confirmation signal to the host 304 via a response signal channel/line 338. The controller 306 is further configured to receive command and address signals from the host 304 via a command and address signal channel/line 340.

In implementations, “deterministic timing” may refer to a scenario where an operation, such as a read/write/computation operation, has a predictable completion time (for write or computation operation) or return time (for read or computation operation), regardless of how much time the operation takes. The operation, such as the read/write/computation operation, must end at a predetermined time (for write or computation operation) or return the result of the operation at the predetermined time (for read or computation operation). In implementations, “non-deterministic timing” may refer to a scenario where the completion or return time of an operation, such as the read/write/computation operation, is not yet determined, but depends on the running time required for the operation.

The controller 306 is further configured to work with deterministic/fixed timing. In implementations, the host 304 is configured to send a read command to the controller 306. The controller 306 is further configured to receive the read command from the host 304 and prepare the data according to the read command. The controller 306 is further configured to send the data to the host 304 with deterministic/fixed timing, for example, 10 ns, 20 ns, and so on, after receiving the read command. In implementations, the host 304 is further configured to send a write command to the controller 306 and the data to be written to the data buffers. The controller 306 is configured to receive the write command from the host 304 and perform a write operation according to the write command without sending back a response/confirmation signal to the host 304.

The controller 306 is further configured to work with non-deterministic/unfixed timing and/or with runtime dependency. The runtime dependency may refer to a dependent relationship of a series of operations where a subsequent operation is depending on a result of a previous operation.

In implementations, the host 304 is further configured to send a read command to the controller 306. The controller 306 is further configured to receive the read command from the host 304 and prepare the data according to the read command with non-deterministic/unfixed timing. The controller 306 is further configured to, after the data is ready, send the response/confirmation signal via the response signal channel/line 338 to the host 304. The response/confirmation signal includes information indicating that the data is ready. Because at which time point the data is ready is non-deterministic/unfixed, the host 304 needs to wait for the response/confirmation signal from the controller 306. The host 304 is further configured to receive the response/confirmation signal from the controller 306 via the response signal channel/line 338.

In implementations, the host 304 is further configured to send a computing command to the controller 306. The controller 306 is further configured to receive the computing command and instruct the computation units to perform computations according to the computing command with non-deterministic/unfixed timing. Because at which time point the computation is completed is non-deterministic and/or depending on the runtime of the computation, the host 304 needs to wait for the response/confirmation signal from the controller 306. The host 304 is further configured to, after receiving the response/confirmation signal, send a get command to the controller 306. The controller 306 is further configured to receive the get command from the host 304 and send the data via the data buffers to the host 304 according to the get command.

In implementations, the host 304 is further configured to send a write command to the controller 306 and the data to be written to the data buffers. The controller 306 is further configured to receive the write operation from the host 304 and perform a write operation according to the write operation with non-deterministic/unfixed timing. The controller 306 is further configured to, after the write operation is completed/successful, send a response/confirmation signal via the response signal channel/line 338 to the host 304. The response/confirmation signal includes information indicating that the write operation is completed/successful.

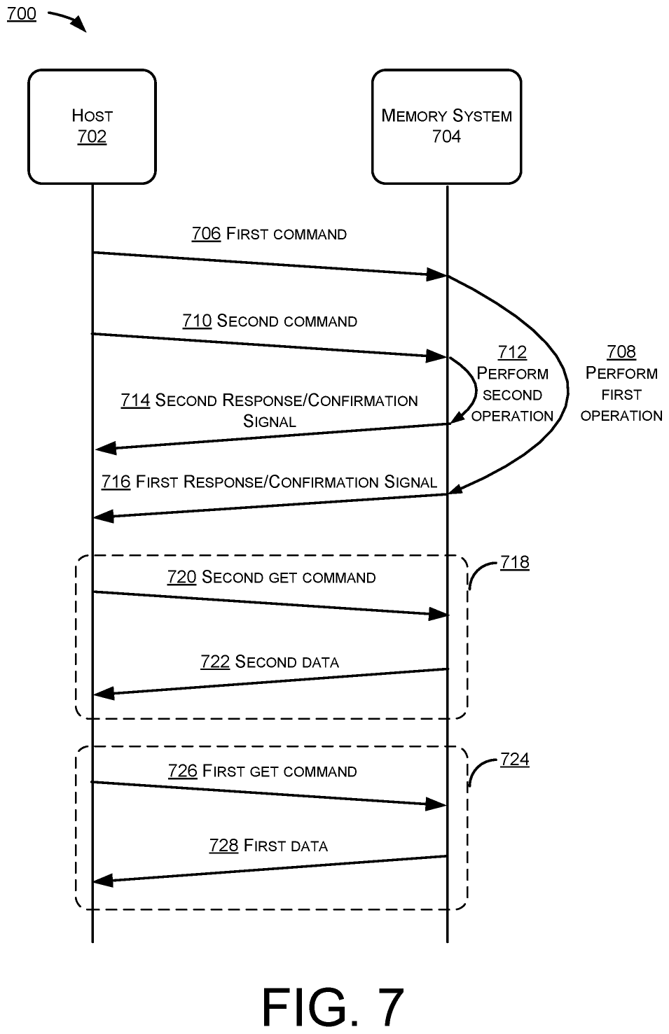

In implementations, the controller 306 and the host 304 may communicate in an out-of-order manner. The term out-of-order refers to that the order of sending/receiving more than one commands is different from the order of receiving/sending more than one response/confirmation signals. More details are described with reference to FIG. 7.

The controller 306 is further configured to request permission from the host 304, allowing the controller 306 of the memory system 302 not to receive command and/or data from the host 304 for a period. In other words, the controller 306 is allowed to take full control of the memory system 302 for the period. In implementations, the term “full control” may refer to a scenario where the controller 306 becomes the sole control party of the memory system 302, which is not controlled by any external host, and does not receive command and/or data from any external host for the period. For example, memory system 302 may take time to perform internal operations, such as moving data between a volatile memory unit and a non-volatile memory unit, performing garbage collection operation in a memory unit, performing computations with the computation unit, and so on. In such cases, the controller 306 may send a request to the host 304 for permission, such that during the requested period, the host 304 would not send command and/or data to the memory system 302. In implementations, the request may be sent from the controller 306 to host 304 via the response/confirmation signal channel/lines 338. The host 304 is further configured to send back the permission to the controller 306 via the command and address signal channel/line 340. The host 304 is further configured to, during the period requested by the controller 306, not send command and/or data to the memory system 302. The period may be set and/or adjusted dynamically based on actual needs.

The controller 306 is further configured to receive metadata from the host 304, from example, through the data buffer_5 320 via the check bit channel/lines CB7.0 342. In implementations, the memory system 302 may work in an ECC mode, in which the memory system 302 can detect and/or correct common kinds of internal data corruption. Additionally or alternatively, the memory system 302 may work in a non-ECC or partial-ECC (customized, non-JEDEC standard compatible ECC algorithms with less ECC bits required) mode. The metadata may include, but is not limited to, information regarding the type of data, a protection level of data, a priority level of data, a persistency requirement of data, customized ECC data, etc. The protection level of data, the priority level of data, the persistency requirement of data, and the customized ECC data may be configured and/or adjusted dynamically. The metadata may be used by the controller 306 to direct the data into different memory units. For example, the persistency requirement of data in the metadata indicates the data need to be saved permanently, and thus the controller 306 saves the data in a persistent memory unit such as Phase Change Memory, STT-RAM, ReRAM, and the like according to the metadata. For example, the persistency requirement of data in the metadata indicates the data do not need to be saved permanently, and thus the controller 306 saves the data in a volatile memory unit such as DRAM and the like according to the metadata. For example, the protection level of data in the metadata is relatively high, and thus the controller 306 may save the data with multiple copies. For example, the customized ECC data may include ECC data customized by the user.

The first computation unit 308 is configured to perform computations. The first computation unit 308 is further configured to communicate/interact with the first memory unit 310. The first computation unit 308 is further configured to communicate with and be controlled by the controller 306. Certain kinds of algorithms may be processed by first computation unit 308 inside the memory system 302, thereby eliminating some of the costly data movement between the memory system 302 and the host 304 and massively improving the overall efficiency of computation. Thus, the first accelerator 334 can accelerate computation and reduce the overhead of data movement.

The first memory unit 310 is configured to store data. The first memory unit 310 is further configured to communicate/interact with the first computation unit 308. The first memory unit 310 is further configured to communicate with and be controlled by the controller 306. In implementations, the first memory unit 310 may include volatile memory, such as SRAM, DRAM, and the like, and non-volatile, such as flash memory, Phase Change Memory, STT-RAM, ReRAM, and the like, or any combination thereof.

The second computation unit 312 is configured to perform computations. The second computation unit 312 is further configured to communicate/interact with the second memory unit 314. The second computation unit 312 is further configured to communicate with and be controlled by the controller 306. Certain kinds of algorithms may be processed by second memory unit 314 inside the memory system 302, thereby eliminating some of the costly data movement between the memory system 302 and the host 304 and massively improving the overall efficiency of computation. Thus, the second accelerator 336 can accelerate computation and reduce the overhead of data movement.

The second memory unit 314 is configured to store data. The second memory unit 314 is further configured to communicate with the second computation unit 312. The second memory unit 314 is further configured to communicate with and be controlled by the controller 306. In implementations, the second memory unit 314 may include volatile memory, such as SRAM, DRAM, and the like, and non-volatile, such as flash memory, Phase Change Memory, STT-RAM, ReRAM, and the like, or any combination thereof.

The respective data buffer of DB_1 316, DB_2 318, DB_3 320, DB_4 322, DB_5 324, DB_6 326, DB_7 328, DB_8 330, . . . , DB_n 332 is configured to maintain the signal integrity and deliver high performance I/O while the data/signals are moving between the host 304 and the memory system 302 via a data bus. The respective data buffer of DB_1 316, DB_2 318, DB_3 320, DB_4 322, DB_5 324, DB_6 326, DB_7 328, DB_8 330, . . . , DB_n 332 is further configured to communicate with the controller 306 to transfer data/signals. As an example, the data buffer DB_5 324 is further configured to communicate with the host 304 via check bit channel/lines CB7:0 342. Additionally or alternatively, other data buffers may be configured to communicate with the host 304 via check bit channel/lines CB7:0 342.

By way of example but not limitation, the data width of the data bus may be any suitable width, for example, 64 bits and the like. The data bus may include 64 data lines DQ0, DQ, DQ2, . . . , DQ63. As an example, data lines DQ63:32 344 are configured to transfer data/signals to/from data buffers DB_1 316, DB_2 318, DB_3 320, and DB_4 from/to the host 304. Data lines DQ31:0 346 are configured to transfer data/signals to/from data buffers DB_6 326, DB_7 328, DB_8 330, . . . , DB_n 332 from/to the host 304.

Check bit channel/lines CB7:0 342 may be configured to transfer data/signals to/from the data buffer DB_5 324 from/to the host 304. In implementations, the check bit lines CB7:0 342 may be configured to transfer ECC signals to/from the data buffer DB_5 324 from/to the host 304. In implementations, the check bit lines CB7:0 342 may be further configured to transfer metadata to/from the data buffer DB_5 324 from/to the host 304.

The command and address signal channel/line 340 is configured to transfer the command and address signals from the host 304 to the controller 306.

The response signal channel/line 338 is configured to transfer the response/confirmation signal from the controller 306 to the host 304.

In implementations, in the memory system 302, the memory units may be mapped as host-managed memory or be treated as software-managed memory. For example, if a memory unit is mapped as the host-managed memory, the host 304 may instruct the memory unit to perform read/write operation via the controller 306. If a memory unit is treated as the software-managed memory, the memory unit is invisible from the point of view of the host 304, and the software is responsible for instructing the memory unit to perform read/write operation via the controller 306.

Collectively, the data bus (including data lines DQ 0:63), the check bit channel/lines CB7:0 342, the command and address signal channel/line 340, and the response signal channel/line 338, may be referred to as transactional interface 348. In other words, the transactional interface 348 may include the data bus (including data lines DQ 0:63), the check bit channel/lines CB7:0 342, the command and address signal channel/line 340, and the response signal channel/line 338. The transactional interface 348 is coupled between the host 304 and the memory system 302. In implementations, the transactional interface 348 may further include other lines/channels such as clock lines, control signal lines, and the like.

With the above example communication schematic 300, response/confirmation signals may be sent from the memory system 302 to the host 304. Thus, when the host 304 performs various operations on the memory system 302, the host 304 may have information regarding whether the operation is successful and when the operation is completed. Therefore, the communication between the host 304 and the memory system 302 can be conducted with accuracy and flexibility. In other words, the memory control is improved.

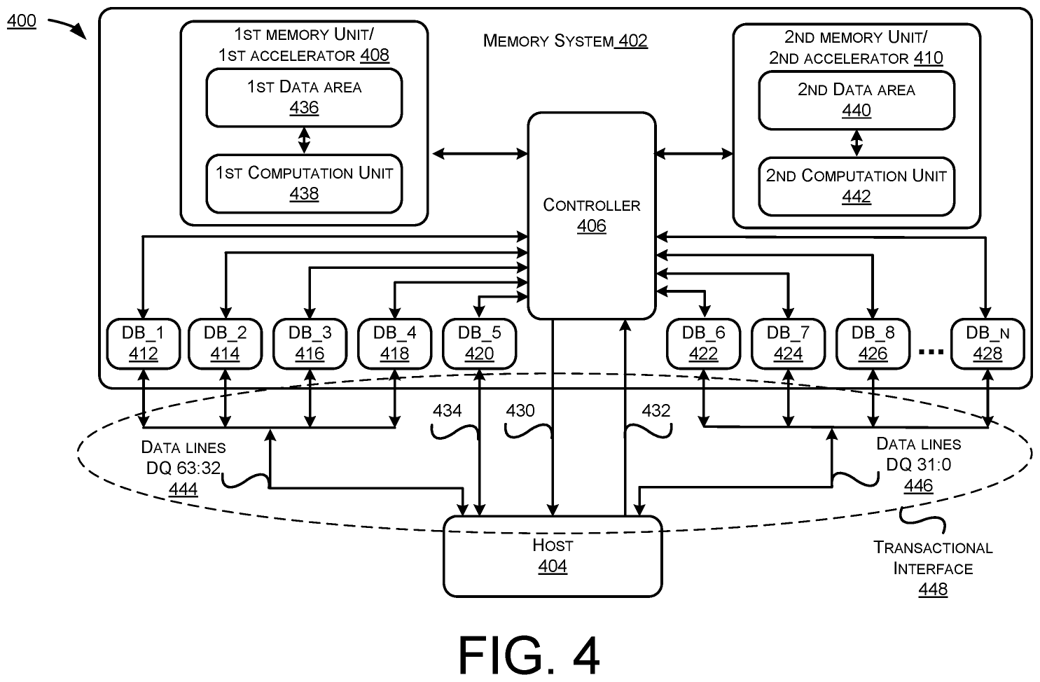

FIG. 4 illustrates an example communication schematic 400 of a memory system 402 and a host 404. In implementations, the memory system 402 may be any suitable type of memory architectures such as DDR based architecture, NVDIMM based architecture and the like. In implementations, the memory system 402 may include volatile memory, such as SRAM, DRAM, and the like, and non-volatile, such as flash memory, Phase Change Memory, STT-RAM, ReRAM, and the like, or any combination thereof. In implementations, the host 404 may include, but is not limited to, a CPU, an ASIC, a GPU, FPGAs, a DSP, or any combination thereof.

Referring to FIG. 4, the memory system 402 may include a controller 406, a first memory unit/first accelerator 408, a second memory unit/second accelerator 410, and n data buffers including DB_1 412, DB_2 414, DB_3 416, DB_4 418, DB_5 420, DB_6 422, DB_7 424, DB_8 426, . . . , DB_n 428. By way of example but not limitation, the total number n of data buffers is a power of 2. Though FIG. 4 shows two memory units/accelerators in the memory system 402, the present disclosure is not limited thereto, and the memory system 402 may include other numbers of memory units/accelerators. In implementations, the number of data buffers is not necessarily the same as the number of memory units.

The controller 406 is configured to communicate with and control the first memory unit/first accelerator 408 and the second memory unit/second accelerator 410. The controller 406 is configured to communicate with and control a respective data buffer of DB_1 412, DB_2 414, DB_3 416, DB_4 418, DB_5 420, DB_6 422, DB_7 424, DB_8 426, . . . , DB_n 428 to transfer data/signals to/from the data buffers.

The controller 406 is further configured to send a response/confirmation signal to the host 404 via a response signal channel/line 430. The controller 406 is further configured to receive command and address signals from the host 404 via a command and address signal channel/line 432.

The controller 406 is further configured to work with deterministic/fixed timing. In implementations, the host 404 is configured to send a read command to the controller 406. The controller 406 is further configured to receive the read command from the host 404 and prepare the data according to the read command. The controller 406 is further configured to send the data to the host 404 with deterministic/fixed timing, for example, 10 ns, 20 ns, and so on, after receiving the read command. In implementations, the host 404 is further configured to send a write command to the controller 406 and the data to be written to the data buffers. The controller 406 is configured to receive the write command from the host 404 and perform a write operation according to the write command without sending back a response/confirmation signal to the host 404.

The controller 406 is further configured to work with non-deterministic/unfixed timing and/or with runtime dependency. The runtime dependency may refer to a dependent relationship of a series of operations where a subsequent operation is depending on a result of a previous operation.

In implementations, the host 404 is further configured to send a read command to the controller 406. The controller 406 is further configured to receive the read command from the host 404 and prepare the data according to the read command with non-deterministic/unfixed timing. The controller 406 is further configured to, after the data is ready, send the response/confirmation signal via the response signal channel/line 430 to the host 404. The response/confirmation signal includes information indicating that the data is ready. Because at which time point the data is ready is non-deterministic/unfixed, the host 404 needs to wait for the response/confirmation signal from the controller 406. The host 404 is further configured to receive the response/confirmation signal from the controller 406 via the response signal channel/line 430.

In implementations, the host 404 is further configured to send a computing command to the controller 406. The controller 406 is further configured to receive the computing command and instruct the memory units to perform computations according to the computing command with non-deterministic/unfixed timing. Because at which time point the computation is completed is non-deterministic and/or depending on the runtime of the computation, the host 404 needs to wait for the response/confirmation signal from the controller 406. The host 404 is further configured to, after receiving the response/confirmation signal, send a get command to the controller 406. The controller 406 is further configured to receive the get command from the host 404 and send the data via the data buffers to the host 404 according to the get command.

In implementations, the host 404 is further configured to send a write command to the controller 406 and the data to be written to the data buffers. The controller 406 is further configured to receive the write operation from the host 404 and perform a write operation according to the write operation with non-deterministic/unfixed timing. The controller 406 is further configured to, after the write operation is completed/successful, send a response/confirmation signal via the response signal channel/line 430 to the host 404. The response/confirmation signal includes information indicating that the write operation is completed/successful.

In implementations, the controller 406 may communicate with the host 404 in the out-of-order manner. More details are described with reference to FIG. 7.

The controller 406 is further configured to request permission from the host 404, allowing the controller 406 of the memory system 402 not to receive command and/or data from the host 404 for a period. In other words, the controller 406 is allowed to take full control of the memory system 402 for the period. The term “full control” may refer to a scenario where the controller 406 becomes the sole control party of the memory system 402, which is not controlled by any external host, and does not receive command and/or data from any external host for the period. For example, memory system 402 may take time to perform internal operations, such as moving data between a volatile memory unit and a non-volatile memory unit, performing garbage collection operation in a memory unit, performing computations with the computation unit, and so on. In such cases, the controller 406 may send a request to the host 404 for permission, such that during the requested period, the host 404 would not send command and/or data to the memory system 302. In implementations, the request may be sent from the controller 406 to host 404 via the response/confirmation signal channel/lines 430. The host 404 is further configured to send back the permission to the controller 406 via the command and address signal channel/line 432. The host 404 is further configured to, during the period requested by the controller 406, not send command and/or data to the memory system 402. The period may be set and/or adjusted dynamically based on actual needs.

The controller 406 is further configured to receive metadata from the host 404, from example, through the data buffer_5 420 via the check bit channel/lines CB7.0 434. In implementations, the memory system 402 may work in an ECC mode, in which the memory system 402 can detect and/or correct common kinds of internal data corruption. Additionally or alternatively, the memory system 402 may work in a non-ECC mode or partial-ECC (customized, non-JEDEC standard compatible ECC algorithms with less ECC bits required). The metadata may include, but is not limited to, information regarding the type of data, a protection level of data, a priority level of data, a persistency requirement of data, customized ECC data, etc. The protection level of data, the priority level of data, the persistency requirement of data, and the customized ECC data may be configured and/or adjusted dynamically. The metadata may be used by the controller 406 to direct the data into different memory units. For example, the persistency requirement of data in the metadata indicates the data need to be saved permanently, and thus the controller 406 saves the data in a persistent memory unit such as Phase Change Memory, STT-RAM, ReRAM, and the like according to the metadata. For example, the persistency requirement of data in the metadata indicates the data do not need to be saved permanently, and thus the controller 406 saves the data in a volatile memory unit such as DRAM and the like according to the metadata. For example, the protection level of data in the metadata is relatively high, and thus the controller 406 may save the data with multiple copies. For example, the customized ECC data may include ECC data customized by the user.

The first memory unit/first accelerator 408 is configured to communicate with and be controlled by the controller 406. In implementations, the first memory unit/first accelerator 408 may include volatile memory, such as such as SRAM, DRAM, and the like, and non-volatile, such as flash memory, Phase Change Memory, STT-RAM, ReRAM, and the like, or any combination thereof.

In implementations, the first memory unit/first accelerator 408 may be configured with the accelerator architecture, for example, the PIM architecture. In implementations, the first memory unit/first accelerator 408 may include a first data area 436 and a first computation unit 438. In implementations, the first data area 436 may also be referred to as a storage area. The first data area 436 is configured to store data. The first computation unit 438 is configured to perform computation. The first data area 436 and the first computation unit 438 are configured to communicate/interact with each other. The first memory unit/first accelerator 408 is further configured to perform computations with the first computation unit 406 under the control of the controller 406. Though FIG. 4 shows that the first memory unit/first accelerator 408 includes one data area and one computation unit, the present disclosure is not limited thereto, and the first memory unit/first accelerator 408 may include other numbers of data areas and computation units. With the PIM architecture, certain kinds of algorithms would be processed by the computation unit inside the memory unit/accelerator 408, thereby eliminating some of the costly data movement between the memory system 402 and the host 404 and massively improving the overall efficiency of computation. In other words, the PIM architecture can accelerate computation and reduce the overhead of data movement.

The second memory unit/second accelerator 410 is configured to communicate with and be controlled by the controller 406. In implementations, the second memory unit/second accelerator 410 may include volatile memory, such as such as SRAM, DRAM, and the like, and non-volatile, such as flash memory, Phase Change Memory, STT-RAM, ReRAM, and the like, or any combination thereof.

In implementations, the second memory unit/second accelerator 410 may be configured with the accelerator architecture, for example, the PIM architecture. In implementations, the second memory unit/second accelerator 410 may include a second data area 440 and a second computation unit 442. In implementations, the second data area 440 may also be referred to as a storage area. The second data area 440 is configured to store data. The second computation unit 442 is configured to perform computation. The second data area 440 and the second computation unit 442 are configured to communicate/interact with each other. The second memory unit/second accelerator 410 is further configured to perform computations with the first computation unit 406 under the control of the controller 406. Though FIG. 4 shows that the second memory unit/second accelerator 410 includes one data area and one computation unit, the present disclosure is not limited thereto, and the second memory unit/second accelerator 410 may include other numbers of data areas and computation units. With the PIM architecture, certain kinds of algorithms would be processed by the computation unit inside the first memory unit/first accelerator 408, thereby eliminating some of the costly data movement between the memory system 402 and the host 404 and massively improving the overall efficiency of computation. In other words, the PIM architecture can accelerate computation and reduce the overhead of data movement.

The respective data buffer of DB_1 412, DB_2 414, DB_3 416, DB_4 418, DB_5 420, DB_6 422, DB_7 424, DB_8 426, . . . , DB_n 428 is configured to maintain the signal integrity and deliver high performance I/O while the data/signals are moving between the host 404 404 and the memory system 402 via a data bus. The respective data buffer of DB_1 412, DB_2 414, DB_3 416, DB_4 418, DB_5 420, DB_6 422, DB_7 424, DB_8 426, . . . , DB_n 428 is further configured to communicate with the controller 406 to transfer data/signals. As an example, data buffer DB_5 420 is further configured to communicate with the host 404 via check bit channel/lines CB7:0 434. Additionally or alternatively, other data buffers may be configured to communicate with the host 404 via check bit channel/lines CB7:0 434.

By way of example but not limitation, the data width of the data bus may be any suitable width, for example, 64 bits. The data bus may include 64 data lines DQ0, DQ, DQ2, . . . , DQ63. As an example, data lines DQ63:32 444 are configured to transfer data/signals to/from data buffers DB_1 412, DB_2 414, DB_3 416, and DB_4 from/to the host 404. Data lines DQ31:0 446 are configured to transfer data/signals to/from data buffers DB_6 422, DB_7 424, DB_8 426, . . . , DB_n 428 from/to the host 404.

Check bit channel/lines CB7:0 434 may be configured to transfer data/signals to/from the data buffer DB_5 420 from/to the host 404. In implementations, the check bit channel/lines CB7:0 434 may be configured to transfer ECC signals to/from the data buffer DB_5 420 from/to the host 404. In implementations, the check bit channel/lines CB7:0 434 may be further configured to transfer metadata to/from the data buffer DB_5 420 from/to the host 404.

The response signal channel/line 430 is configured to transfer the response/confirmation signal from the controller 406 to the host 404.

The command and address signal channel/line 432 is configured to transfer the command and address signals from the host 404 to the controller 406.

In implementations, in the memory system 402, the memory units may be mapped as host-managed memory or be treated as software-managed memory. For example, if a memory unit is mapped as the host-managed memory, the host 404 may instruct the memory unit to perform read/write operation via the controller 406. If a memory unit is treated as the software-managed memory, the memory unit is invisible from the point of view of the host 404, and the software is responsible for instructing the memory unit to perform read/write operation via the controller 406.

Collectively, the data bus (including data lines DQ 0:64), the check bit channel/lines CB7:0 434, the command and address signal channel/line 432, and the response signal channel/line 430, may be referred to as transactional interface 448. In other words, the transactional interface 448 may include the data bus (including data lines DQ 0:64), the check bit channel/lines CB7:0 434, the command and address signal channel/line 432, and the response signal channel/line 430. The transactional interface 448 is coupled between the host 404 and the memory system 402. In implementations, the transactional interface 448 may further include other lines/channels such as clock lines, control signal lines, and the like.

With the above example communication schematic 400, response/confirmation signals may be sent from the memory system 402 to the host 404. Thus, when the host 404 performs various operations on the memory system 402, the host 404 may have information regarding whether the operation is successful and when the operation is completed. Therefore, the communication between the host 404 and the memory system 402 can be conducted with accuracy and flexibility. In other words, the memory control is improved.

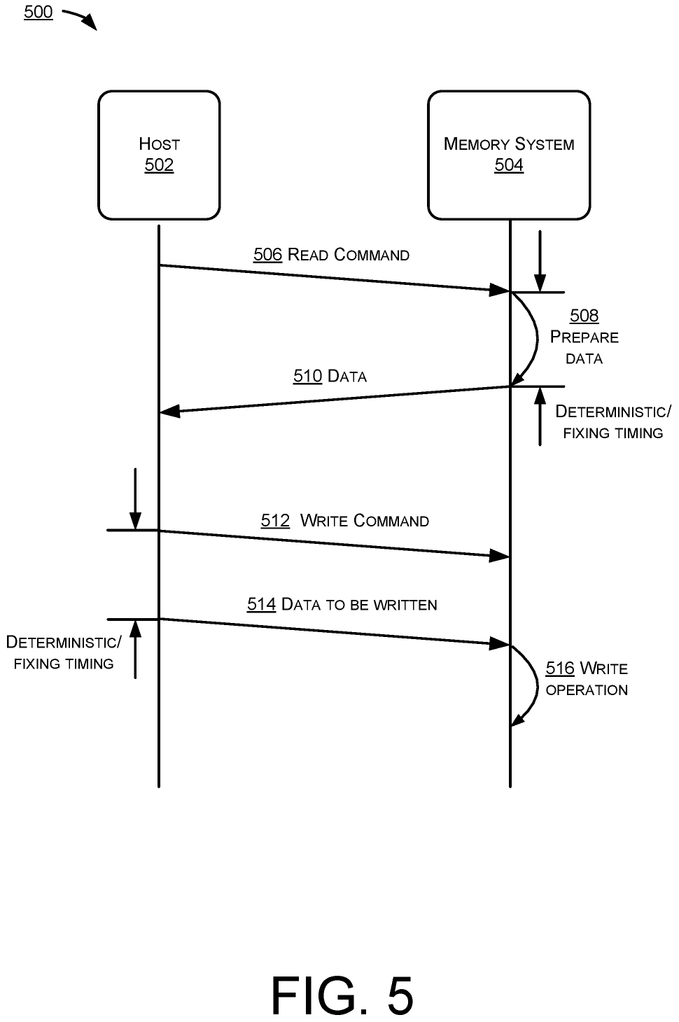

FIG. 5 illustrates an example diagram 500 of communications between a host 502 and a memory system 504.

Referring to FIG. 5, at 506, the host 502 sends a read command to the memory system 504.

At 508, the memory system 504 prepares the data with deterministic/fixed timing, for example, 10 ns, 20 ns, and so on, after receiving the read command.

At 510, the memory system 504 sends the data to the host 502.

At 512, the host 502 sends a write command to the memory system 504.

At 514, the host 502 sends data to be written to the memory system 504 with deterministic/fixed timing. In implementations, the host 502 sends data to be written to the memory system 504 at a deterministic/timing time point, for example, 5 ns, 10 ns, and so on, after sending the write command.

At 516, the memory system 504 performs the write operation according to the write command.

The example diagram 500 of communications between the host 502 and the memory system 504 with deterministic timing/fixed timing is for the purpose of illustration, and the present disclosure is not limited thereto. Though steps/operations are shown in a particular order in FIG. 5, these steps/operations may be performed in a different order. Any steps/operations in FIG. 5 may be performed once, twice, or multiple times. Moreover, additional steps/operations may be added into the example diagram 500.

In the above example diagram 500, response/confirmation signals may be sent from the memory system 504 to the host 502. Thus, when the host 504 performs various operations on the memory system 504, the host 502 may have information regarding whether the operation is successful and when the operation is completed. Therefore, the communication between the host 502 and the memory system 504 can be conducted with accuracy and flexibility. In other words, the memory control is improved.

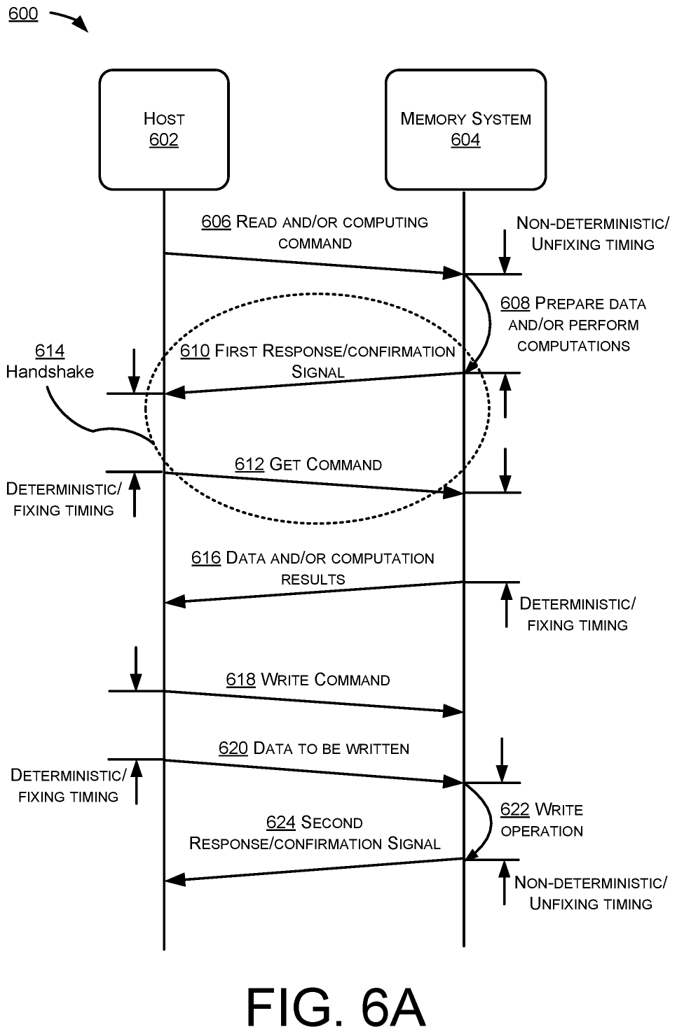

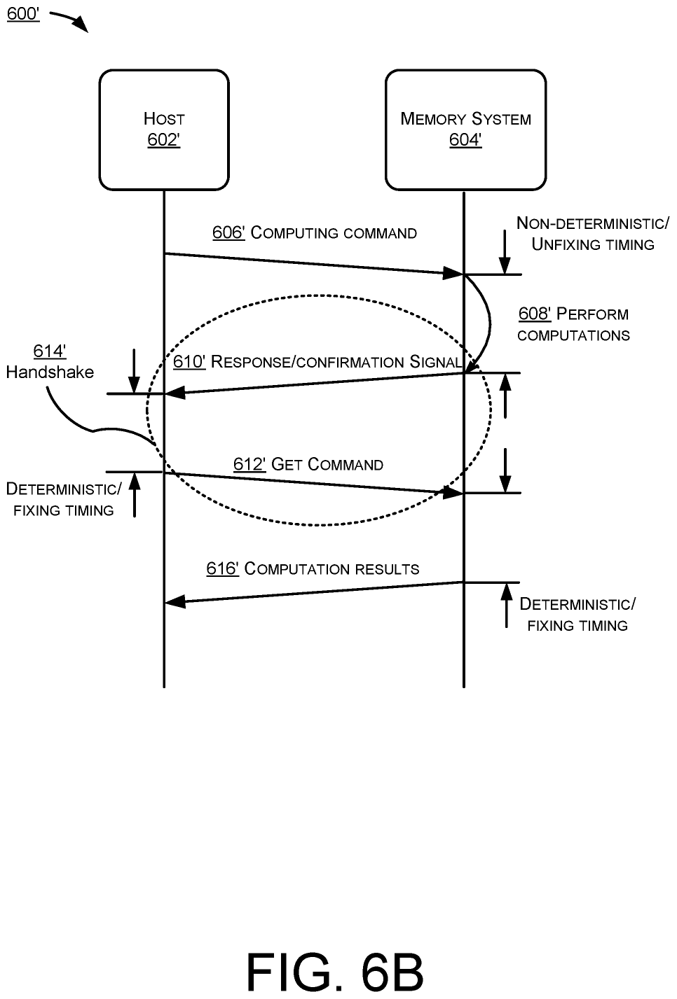

FIG. 6A illustrates an example diagram 600 of communications between a host 602 and a memory system 604.

Referring to FIG. 6A, at 606, the host 602 sends a read and/or computing command to the memory system 604.

At 608, the memory system 604 prepares the data and/or performs computation according to the read and/or computing command with non-deterministic/unfixed timing. In implementations, at which time point the data is ready and/or the computation is completed is non-deterministic and/or depending on the runtime of the computation.

At 610, after the data is ready and/or the computation is completed, the memory system 604 sends a first response/confirmation signal to the host 602. The first response/confirmation signal includes information indicating that the data is ready and/or the computation is completed.

At 612, the host 602 sends a get command to the memory system 604 with deterministic/fixed timing. In implementations, the host 602 sends the get command at a deterministic/timing time point, for example, 5n, 10 ns, and so on, after receiving the response/confirmation signal from the memory system 604.

The dashed channel/line circle 614 represents that the operations performed at 610 and 612 may be referred to as a handshake process between the host 602 the memory system 604.

At 616, the memory system 604 sends the data and/or the computation results to the host 602 with deterministic/fixed timing. In implementations, the memory system 604 sends the data and/or computation results to the host 602 at a deterministic/timing time point, for example, 10 ns, 20 ns, and so on, after receiving the get command from the host 602.

At 618, the host 602 sends a write command to the memory system 604.

At 620, the host 602 sends the data to be written to the memory system 604 with deterministic/fixed timing. In implementations, the host 602 sends the data to be written to the memory system 604 at a deterministic/timing time point, for example, 5 ns, 10 ns, and so on, after sending the write command.

At 622, the memory system 604 performs the write operation according to the write command with non-deterministic timing.

At 624, after the write operation is completed, the memory system 604 sends a second response/confirmation signal to the host 602. The second response/confirmation signal includes information indicating that the write operation is completed/successful.

The example diagram 600 of communications between the host 602 and the memory system 604 with determinist/fixed timing and non-deterministic/unfixed timing is for the purpose of illustration, and the present disclosure is not limited thereto. Though steps/operations are shown in a particular order in FIG. 6A, these steps/operations may be performed in a different order. Any steps/operations in FIG. 6A may be performed once, twice, or multiple times. Moreover, additional steps/operations may be added into the example diagram 600.

In the above example diagram 600, response/confirmation signals may be sent from the memory system 604 to the host 602. Thus, when the host 604 performs various operations on the memory system 604, the host 602 may have information regarding whether the operation is successful and when the operation is completed. Therefore, the communication between the host 602 and the memory system 604 can be conducted with accuracy and flexibility. In other words, the memory control is improved.

FIG. 6B illustrates an example diagram 600′ of communications between a host 602′ and a memory system 604′.

Referring to FIG. 6B, at 606′, the host 602′ sends a computing command to the memory system 604′.

At 608′, the memory system 604′ performs computation according to the computing command with non-deterministic/unfixed timing. In implementations, at which time point the computation is completed is non-deterministic and/or depending on the runtime of the computation.

At 610′, after the computation is completed, the memory system 604′ sends a first response/confirmation signal to the host 602′. The first response/confirmation signal includes information indicating that the computation is completed.

At 612′, the host 602′ sends a get command to the memory system 604′ with deterministic/fixed timing. In implementations, the host 602′ sends the get command at a deterministic/timing time point, for example, 5n, 10 ns, and so on, after receiving the response/confirmation signal from the memory system 604′. In implementations, the operation at 612′ may be optional.

The dashed channel/line circle 614′ represents that the operations performed at 610′ and 612′ may be referred to as a handshake process between the host 602′ the memory system 604′.

At 616′, the memory system 604′ sends the computation results to the host 602′ with deterministic/fixed timing. In implementations, the memory system 604′ sends the computation results to the host 602′ at a deterministic/timing time point, for example, 10 ns, 20 ns, and so on, after receiving the get command from the host 602′. In implementations, the operation at 612′ may be optional.

In implementations, after the memory system 604′ completes the computation, the host 602′ may not need to get the computation results all the time. For example, the computation results may be intermediate results. Therefore, the operations at 612′ and 616′ may be optional.

The example diagram 600′ of communications between the host 602′ and the memory system 604′ with determinist/fixed timing and non-deterministic/unfixed timing is for the purpose of illustration, and the present disclosure is not limited thereto. Though steps/operations are shown in a particular order in FIG. 6B, these steps/operations may be performed in a different order. Any steps/operations in FIG. 6B may be performed once, twice, or multiple times. Moreover, additional steps/operations may be added into the example diagram 600′.

In the above example diagram 600′, response/confirmation signals may be sent from the memory system 604′ to the host 602′. Thus, when the host 604′ performs various operations on the memory system 604′, the host 602′ may have information regarding whether the operation is successful and when the operation is completed. Therefore, the communication between the host 602′ and the memory system 604′ can be conducted with accuracy and flexibility. In other words, the memory control is improved.

FIG. 7 illustrates an example diagram of communications between a host 702 and a memory system 704 in the out-of-order manner.

Referring to FIG. 7, at 706, the host 702 sends a first command to the memory system 704. In implementations, the first command may include, but is not limited to, a read command, a computing command, a write command and data to be written, or any combination thereof.

At 708, the memory system 704 performs a first operation according to the first command. In implementations, the first operation may include, but is not limited to, preparing data, performing computation, performing a write operation, or any combination thereof.

At 710, the host 702 sends a second command to the memory system 704. In implementations, the second command may include, but is not limited to, a read command, a computing command, a write command and data to be written, or any combination thereof.

At 712, the memory system 704 performs a second operation according to the second command. In implementations, the second operation may include, but is not limited to, preparing data, performing computation, performing a write operation, or any combination thereof.

At 714, the memory system 704 sends a second response/confirmation signal to the host 702. The second response/confirmation signal includes information indicating that the second operation is completed.

At 716, the memory system 704 sends a first response/confirmation signal to the host 702. The first response/confirmation signal includes information indicating that the first operation is completed.

The dashed line box 718 illustrates operations to be performed when the second command includes the read command and/or computing command.

At 720, the host 702 sends a second get command to the memory system 704.

At 722, the memory system 704 sends the second data to the host.

The dashed line box 724 illustrates operations to be performed when the first command includes the read command and/or computing command.

At 726, the host 702 sends a first get command to the memory system 704.

At 728, the memory system 704 sends the first data to the host.

As shown in FIG. 7, the first command is sent from the host 702 to the memory system 704 prior to the second command. However, the first response/confirmation signal is sent from the memory system 704 to the host 702 after the second response/confirmation signal. Thus, the order of sending/receiving more than one commands is different from the order of receiving/sending more than one response/confirmation signals. Therefore, the host 702 and the memory system 704 communicate in the out-of-order manner.

The example diagram 700 of communications between the host 702 and the memory system 704 in the out-of-order manner is for the purpose of illustration, and the present disclosure is not limited thereto. Though steps/operations are shown in a particular order in FIG. 7, these steps/operations may be performed in a different order. Any steps/operations in FIG. 7 may be performed once, twice, or multiple times. Moreover, additional steps/operations may be added into the example diagram 700.

In the above example diagram 700, response/confirmation signals may be sent from the memory system 704 to the host 702. Thus, when the host 704 performs various operations on the memory system 704, the host 702 may have information regarding whether the operation is successful and when the operation is completed. Therefore, the communication between the host 702 and the memory system 704 can be conducted with accuracy and flexibility. In other words, the memory control is improved.

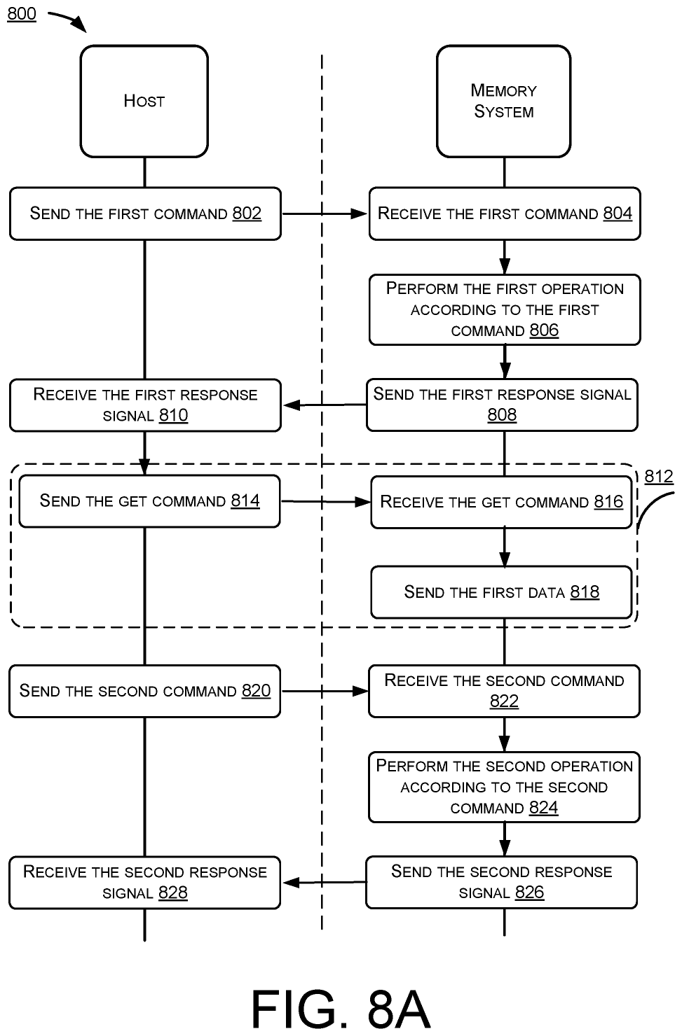

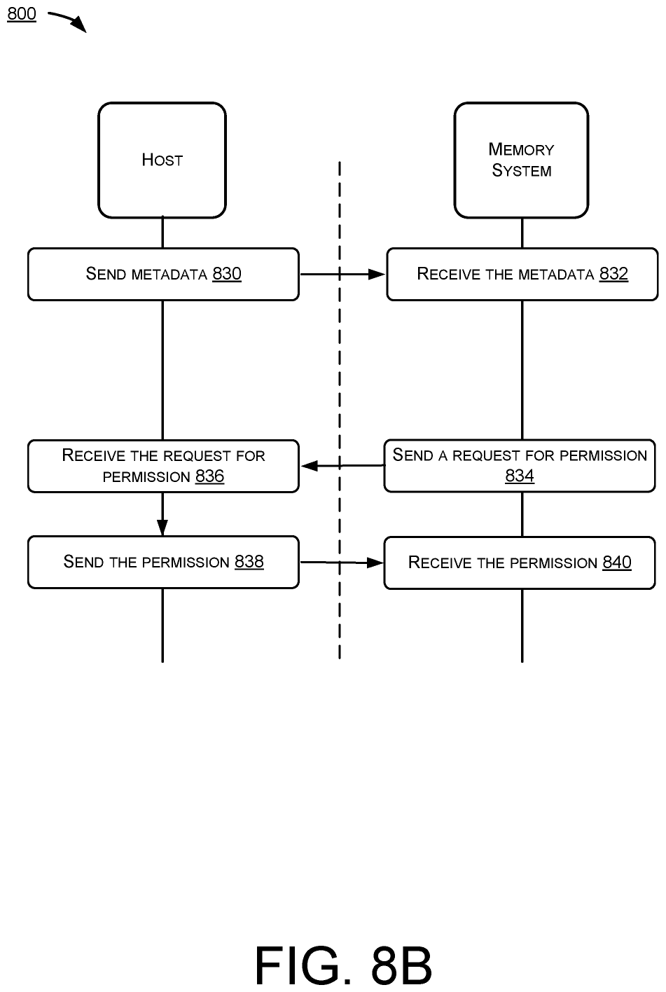

FIGS. 8A and 8B illustrate an example process 800 of memory control.

Referring to FIG. 8A, at block 802, the host sends the first command to the memory system. In implementations, the first command includes a read command. Additionally or alternatively, the first command includes a computing command. Additionally or alternatively, the first command includes a write command and data to be written.

At block 804, the memory system receives the first command from the host.

At block 806, in response to receiving the first command, the memory system performs the first operation according to the first command. In implementations, the first operation is performed with non-deterministic/unfixed timing. Details of non-deterministic timing are as described above and shall not be repeated herein. In implementations, performing the first operation includes preparing data according to the read command. Additionally or alternatively, performing the first operation includes performing computation according to the computing command. Additionally or alternatively, performing the first operation includes performing a write operation according to the write command.

At block 808, after the first operation is completed, the memory system sends the first response signal to the host. In implementations, the first response signal includes information indicating that the first operation is completed.

At block 810, the host receives the first response signal from the memory system. In implementations, the first response signal is received with non-deterministic/unfixed timing. Details of non-deterministic timing are as described above and shall not be repeated herein.

The dashed line box 812 illustrates operations to be performed when the first command includes the read command and/or computing command.

At block 814, in response to receiving the first response signal, the host sends the get command to the memory system.

At block 816, the memory system receives the get command from the host.

At block 818, in response to receiving the get command from the host, the memory system sends the first data to the host.

At block 820, the host sends the second command to the memory system. In implementations, the second command includes a read command. Additionally or alternatively, the second command includes a computing command. Additionally or alternatively, the second command includes a write command and data to be written.

At block 822, the memory system receives the second command from the host.

At block 824, in response to receiving the second command, the memory system performs the second operation according to the second command. In implementations, the second operation is performed with non-deterministic/unfixed timing. Details of non-deterministic/unfixed timing are as described above and shall not be repeated herein. In implementations, performing the second operation includes preparing data according to the read command. Additionally or alternatively, performing the second operation includes performing computation according to the computing command. Additionally or alternatively, performing the second operation includes performing a write operation according to the write command.

At block 826, after the second operation is completed, the memory system sends the second response signal to the host. In implementations, the second response signal includes information indicating that the second operation is completed.

At block 828, the host receives the second response signal from the memory system. In implementations, the second response signal is received with non-deterministic timing. Details of non-deterministic timing are as described above and shall not be repeated herein.

In implementations, the host and the memory system may communicate in the out-of-order manner. For example, on the host side, the host may send the first command prior to the second command to the memory system. The host may receive the second response signal prior to the first response signal from the memory system. On the memory system side, the memory system may receive the first command prior to the second command from the host. The memory system may send the second response signal prior to the first response signal to the host. As such, the order of sending/receiving more than one commands is different from the order of receiving/sending more than one response/confirmation signals, and thus the host and the memory system communicate in the out-of-order manner. More details are described with reference to FIG. 7.

Referring to FIG. 8B, at block 830, the host sends metadata to the memory system. Details of the metadata are as described above and shall not be repeated herein.

At block 832, the memory system receives the metadata from the host.

At block 834, the memory system sends a request for permission to the host. Details of the permission are as described above and shall not be repeated herein.

At block 836, the host receives the request for permission from the memory system.

At block 838, in response to receiving the request for permission, the host sends the permission to the memory system allowing the memory system not to receive command and/or data from the host for a period. In other words, the controller is allowed to take full control of the memory system for the period. The details of full control is as described above and shall not be repeated herein.

At block 840, the memory system receives the permission from the host.

The example process 800 is for the purpose of illustration, and the present disclosure is not limited thereto. Though blocks/boxes are shown in a particular order in FIGS. 8A and 8B, these blocks/boxes may be performed in a different order. Any block/box in FIGS. 8A and 8B may be performed once, twice, or multiple times. Moreover, additional blocks/boxes may be added into the example process 800. Furthermore, any block/box may be combined/split.

With the above example process 800, response signals may be sent from the memory system to the host. Thus, when the host performs various operations on the memory system, the host may have information regarding whether the operation is successful and when the operation is completed. Therefore, the communication between the host and the memory system can be conducted with accuracy and flexibility. In other words, the memory control is improved.

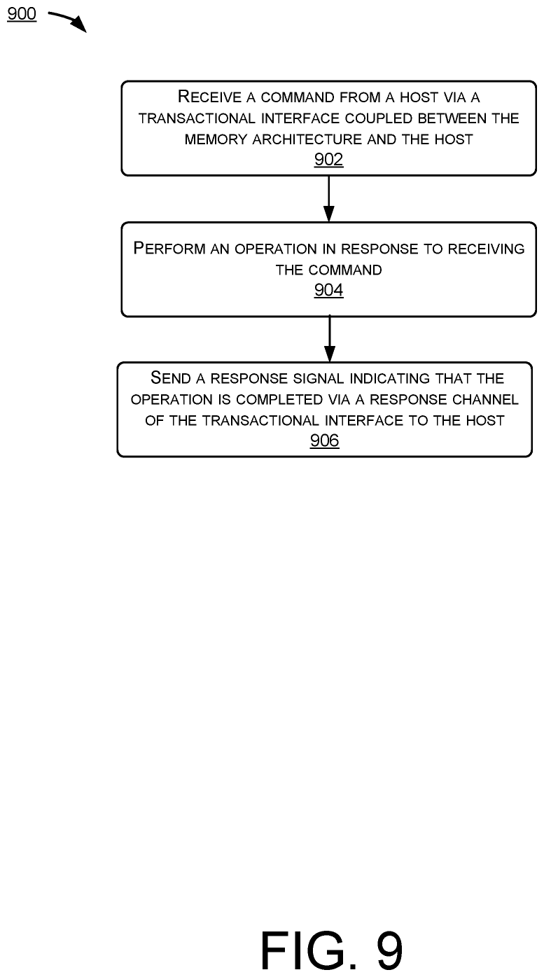

FIG. 9 illustrates an example process 900 of memory control.

At block 902, a memory architecture receives a command from a host via a transactional interface coupled between the memory architecture and the host. In implementations, the memory architecture may receive a read command. In implementations, the memory architecture may receive a computing command. In implementations, the memory architecture may receive a write command and data to be written.

At block 904, the memory architecture performs an operation in response to receiving the command. In implementations, the operation may be performed with non-deterministic timing. In implementations, the memory architecture prepares data according to the read command. In implementations, the memory architecture performs computation according to the computing command. In implementations, the memory architecture performs a write operation according to the write command.

At block 906, the memory architecture sends a response signal indicating that the operation is completed via a response signal channel of the transactional interface to the host.

In implementations, the memory architecture may receive metadata from the host via the transactional interface. In implementations, the memory architecture may send a request for permission via the transactional interface to the host, and receive the permission from the host via the transactional interface allowing the memory architecture not to receive command and/or data from the host for a period. In other words, the controller is allowed to take full control of the memory architecture for the period. The details of full control is as described above and shall not be repeated herein.

With the above example process 900, response signals may be sent from the memory system to the host. Thus, when the host performs various operations on the memory system, the host may have information regarding whether the operation is successful and when the operation is completed. Therefore, the communication between the host and the memory system can be conducted with accuracy and flexibility. In other words, the memory control is improved.

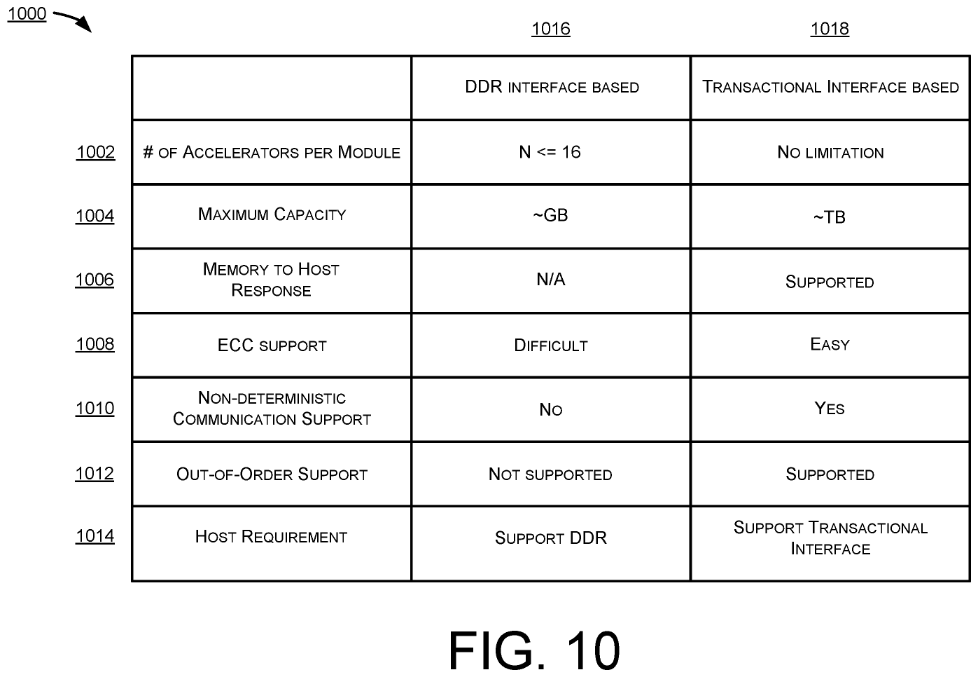

FIG. 10 illustrates an example table 1000 comparing characteristics of a conventional DDR interface based memory architecture and a transactional interface based memory architecture. In implementations, the transactional interface based memory architecture may be implemented with the memory systems as described above with reference to FIGS. 4-9.

Referring to FIG. 10, table 1000 may include the following.

Row 1002 illustrates the number of accelerators per module of the conventional DDR interface based memory architecture and the transactional interface based memory architecture. Row 1004 illustrates the maximum capacity of the conventional DDR interface based memory architecture and the transactional interface based memory architecture. Row 1006 illustrates whether the memory to host response is supported by the conventional DDR interface based memory architecture and the transactional interface based memory architecture. Row 1008 illustrates whether the ECC support is difficult or easy for the conventional DDR interface based memory architecture and the transactional interface based memory architecture. Row 1010 illustrates whether non-deterministic communication is supported by the conventional DDR interface based memory architecture and the transactional interface based memory architecture. Row 1012 illustrates whether the conventional DDR interface based memory architecture and the transactional interface based memory architecture support out-of-order communication. Row 1014 illustrates the host requirements of the conventional DDR interface based memory architecture and the transactional interface based memory architecture.

Column 1016 illustrates characteristics of the conventional DDR interface based module as follows. For example, the number of accelerators per module N is less than or equal to 16, because the conventional DDR interface based module may include 16 chips at most. The maximum capacity of the conventional DDR interface based module is at a magnitude of GB. The memory to host response is not applicable (N/A) for the conventional DDR interface based module, because the conventional DDR interface based module cannot send the response/confirmation signal. The ECC support is relatively difficult for the conventional DDR interface based module compared with the transactional interface based memory architecture. The non-deterministic communication is not supported by the conventional DDR interface based module, because the conventional DDR interface based module cannot send the response/confirmation signal. The conventional DDR interface based module does not support the out-of-order communication, because the conventional DDR interface based module cannot send the response/confirmation signal. Regarding the host requirement, the conventional DDR interface based module requires that the host has the structure/logic to support conventional DDR operations.

Column 1018 illustrates characteristics of the transactional interface based memory architecture as follows. For example, there is no limitation of the number of accelerators per module of the transactional interface based memory architecture. The maximum capacity of the transactional interface based memory architecture is at a magnitude of TB. The memory to host communication is supported by the transactional interface based memory architecture. The ECC support is relatively easy for the transactional interface based memory architecture compared with the conventional DDR interface based module. The non-deterministic communication is supported by the transactional interface based memory architecture. The transactional interface based memory architecture supports the out-of-order communication. Regarding the host requirement, the transactional interface based memory architecture requires that the host has the structure/logic to support the transactional interface operations.

In view of the above, the characteristics of the transactional interface based module are improved compared with the conventional DDR interface based module.

The processes, mechanisms, and systems described herein are only examples and are not intended to suggest any limitation as to the scope of the present disclosure. The numbers and values used herein are for the purpose of description, rather than limiting the scope of the disclosure. The processes, mechanisms, and systems described herein may be implemented in any computing devices, systems, environments and/or configurations including, but is not limited to, personal computers, server computers, hand-held or laptop devices, multiprocessor systems, microprocessor-based systems, set-top boxes, game consoles, programmable consumer electronics, network PCs, minicomputers, mainframe computers, distributed computing environments.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random access memory (RAM)) and/or non-volatile memory (such as read-only memory (ROM), flash memory, etc.). The computer-readable storage media may also include additional removable storage and/or non-removable storage including, but is not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase-change memory (PRAM), static random-access memory (SRAM), DRAM, other types of RAM, ROM, electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. As defined herein, computer-readable storage media do not include communication media.

The computer-readable instructions stored on one or more non-transitory computer-readable storage media that, when executed by one or more processors, may perform operations described above with reference to FIGS. 1-9. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

### Example Clauses

Clause 1. A memory architecture, comprising: one or more accelerators, a respective accelerator of the one or more accelerators including a respective storage area configured to store data and a respective computation unit configured to perform computation, the respective storage area and the respective computation unit being configured to interact with each other; a controller, coupled with the one or more accelerators, the controller being configured to control the one or more accelerators; receive a command from a host; and perform an operation in response to receiving the command; and a transactional interface, coupled between the controller and the host, the transactional interface including a command and address signal channel, configured to transfer command and address signals from the host to the controller.

Clause 2. The memory architecture of clause 1, wherein the controller is further configured to perform the operation with deterministic timing to complete the operation at a predetermined time if the operation includes at least one of a read operation, a computation operation, and a write operation; and return a result of the operation to the host at the predetermined time if the operation includes at least one of a read operation and a computation operation.

Clause 3. The memory architecture of clause 1, wherein the transactional interface further includes a response signal channel; and wherein the controller is further configured to perform the operation with non-deterministic timing; and send a response signal indicating that the operation is completed to the host when the operation is completed via the response signal channel.

Clause 4. The memory architecture of clause 1, wherein the controller is further configured to send a request for permission to the host; and receive the permission from the host allowing the memory architecture not to receive command and/or data from the host for a period.

Clause 5. The memory architecture of clause 1, wherein the transactional interface further includes a data bus, configured to transfer data from/to the host to/from the memory architecture; and a check bit channel, configured to transfer metadata and/or Error-Correcting Code (ECC) from/to the host to/from the memory architecture.

Clause 6. A system, comprising: a memory architecture, including one or more accelerators, a respective accelerator of the one or more accelerators including a respective storage area configured to store data and a respective computation unit configured to perform computation, the respective storage area and the respective computation unit being configured to interact with each other; a controller, coupled with the one or more accelerators, the controller being configured to control the one or more accelerators; receive a command from a host; and perform an operation in response to receiving the command; and a transactional interface, coupled between the controller and the host, the transactional interface including a command and address signal channel, configured to transfer command and address signals from the host to the controller; the host, coupled with the transactional interface, the host being configured to send the command and address signals.

Clause 7. The system of clause 6, wherein the controller is further configured to perform the operation with deterministic timing to complete the operation at a predetermined time if the operation includes at least one of a read operation, a computation operation, and a write operation; and return a result of the operation to the host at the predetermined time if the operation includes at least one of a read operation and a computation operation.

Clause 8. The system of clause 6, wherein the transactional interface further includes a response signal channel; and wherein the controller is further configured to perform the operation with non-deterministic timing; and send a response signal indicating that the operation is completed to the host when the operation is completed via the response signal channel.

Clause 9. The system of clause 6, wherein the controller is further configured to send a request for permission to the host; and receive the permission from the host allowing the memory architecture not to receive command and/or data from the host for a period.

Clause 10. A method comprising: receiving, by a memory architecture, a command from a host via a transactional interface coupled between the memory architecture and the host; performing, by the memory architecture, an operation in response to receiving the command; and sending, by the memory architecture, a response signal indicating that the operation is completed via a response signal channel of the transactional interface to the host.

Clause 11. The method of clause 10, wherein performing, by the memory architecture, an operation in response to receiving the command includes performing, by the memory architecture, the operation with non-deterministic timing.

Clause 12. The method of clause 10, wherein receiving, by the memory architecture, the command from the host via the transactional interface coupled between the memory architecture and the host includes receiving, by the memory architecture, a read command from the host via the transactional interface coupled between the memory architecture and the host.

Clause 13. The method of clause 12, wherein performing, by the memory architecture, the operation in response to receiving the command includes preparing data by the memory architecture in response to receiving the read command.

Clause 14. The method of clause 13, further comprising: receiving, by the memory architecture, a get command from the host; and sending, by the memory architecture, the data to the host in response to receiving the get command from the host.

Clause 15. The method of clause 10, wherein receiving, by the memory architecture, the command from the host via the transactional interface coupled between the memory architecture and the host includes receiving, by the memory architecture, a computing command from the host via the transactional interface coupled between the memory architecture and the host.

Clause 16. The method of clause 15, wherein performing, by the memory architecture, the operation in response to receiving the command includes performing, by the memory architecture, a computation operation in response to receiving the computing command.

Clause 17. The method of clause 10, wherein receiving, by the memory architecture, the command from the host via the transactional interface coupled between the memory architecture and the host includes receiving, by the memory architecture, a write command and data to be written, from the host via the transactional interface coupled between the memory architecture and the host.

Clause 18. The method of clause 17, wherein performing, by the memory architecture, the operation in response to receiving the command includes performing, by the memory architecture, a write operation in response to receiving the write command and data to be written.

Clause 19. The method of clause 10, further comprising: receiving, by the memory architecture, metadata and/or Error-Correcting Code (ECC) from the host via the transactional interface coupled between the memory architecture and the host.

Clause 20. The method of clause 10, further comprising: sending, by the memory architecture, a request for permission to the host; and receiving the permission from the host allowing the memory architecture not to receive command and/or data from the host for a period.

Clause 21. A computer-readable storage medium storing computer-readable instructions executable by one or more processors, that when executed by the one or more processors, cause the one or more processors to perform acts comprising: sending, by a host, a command to a memory architecture via a transactional interface coupled between the memory architecture and the host; and receiving, by the host, a response signal indicating that an operation is completed, from the memory architecture via a response signal channel of the transactional interface coupled between the memory architecture and the host.

Clause 22. The computer-readable storage medium of clause 21, wherein the response signal is received by the host from the memory architecture with non-deterministic timing.

Clause 23. The computer-readable storage medium of clause 21, wherein sending, by the host, the command to the memory architecture via the transactional interface coupled between the memory architecture and the host includes sending, by the host, a read command to the memory architecture via the transactional interface coupled between the memory architecture and the host.

Clause 24. The computer-readable storage medium of clause 23, the acts further comprising: sending, by the host, a get command to the memory architecture; and receiving, by the host, data from the memory architecture.

Clause 25. The computer-readable storage medium of clause 21, wherein sending, by the host, the command to the memory architecture via the transactional interface coupled between the memory architecture and the host includes sending, by the host, a computing command to the memory architecture via the transactional interface coupled between the memory architecture and the host.

Clause 26. The computer-readable storage medium of clause 21, wherein sending, by the host, the command to the memory architecture via the transactional interface coupled between the memory architecture and the host includes sending, by the host, a write command and data to be written to the memory architecture via the transactional interface coupled between the memory architecture and the host.

Clause 27. The computer-readable storage medium of clause 21, the acts further comprising: sending, by the host, metadata and/or Error-Correcting Code (ECC) to the memory architecture via the transactional interface coupled between the memory architecture and the host.

Clause 28. The computer-readable storage medium of clause 21, the acts further comprising: receiving, by the host, a request for permission from the memory architecture; and sending, by the host, the permission to the memory architecture in response to receiving the request allowing the memory architecture not to receive command and/or data from the host for a period.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A memory architecture, comprising:
one or more accelerators, a respective accelerator of the one or more accelerators including a respective storage area configured to store data and a respective computation unit configured to perform computation, the respective storage area and the respective computation unit being configured to interact with each other;
a controller, coupled with the one or more accelerators, the controller being configured to
control the one or more accelerators;
receive a command from a host; and
perform an operation in response to receiving the command; and
a transactional interface, coupled between the controller and the host, the transactional interface including a command and address signal channel, configured to transfer command and address signals from the host to the controller.

2. The memory architecture of claim 1, wherein the controller is further configured to
perform the operation with deterministic timing to complete the operation at a predetermined time if the operation includes at least one of a read operation, a computation operation, and a write operation; and
return a result of the operation to the host at the predetermined time if the operation includes at least one of a read operation and a computation operation.

3. The memory architecture of claim 1, wherein the transactional interface further includes a response signal channel; and
wherein the controller is further configured to
perform the operation with non-deterministic timing; and
send a response signal indicating that the operation is completed to the host when the operation is completed via the response signal channel.

4. The memory architecture of claim 1, wherein the controller is further configured to
send a request for permission to the host; and
receive the permission from the host allowing the memory architecture not to receive command and/or data from the host for a period.

5. The memory architecture of claim 1, wherein the transactional interface further includes
a data bus, configured to transfer data from/to the host to/from the memory architecture; and
a check bit channel, configured to transfer metadata and/or Error-Correcting Code (ECC) from/to the host to/from the memory architecture.

6. A system, comprising:
a memory architecture, including
one or more accelerators, a respective accelerator of the one or more accelerators including a respective storage area configured to store data and a respective computation unit configured to perform computation, the respective storage area and the respective computation unit being configured to interact with each other;
a controller, coupled with the one or more accelerators, the controller being configured to
control the one or more accelerators;
receive a command from a host; and
perform an operation in response to receiving the command; and
a transactional interface, coupled between the controller and the host, the transactional interface including a command and address signal channel, configured to transfer command and address signals from the host to the controller;
the host, coupled with the transactional interface, the host being configured to send the command and address signals.

7. The system of claim 6, wherein the controller is further configured to
perform the operation with deterministic timing to complete the operation at a predetermined time if the operation includes at least one of a read operation, a computation operation, and a write operation; and
return a result of the operation to the host at the predetermined time if the operation includes at least one of a read operation and a computation operation.

8. The system of claim 6, wherein the transactional interface further includes a response signal channel; and
wherein the controller is further configured to
perform the operation with non-deterministic timing; and
send a response signal indicating that the operation is completed to the host when the operation is completed via the response signal channel.

9. The system of claim 6, wherein the controller is further configured to
send a request for permission to the host; and
receive the permission from the host allowing the memory architecture not to receive command and/or data from the host for a period.

10. A method comprising:
receiving, by a memory architecture, a command from a host via a transactional interface coupled between the memory architecture and the host;
performing, by the memory architecture, an operation in response to receiving the command; and
sending, by the memory architecture, a response signal indicating that the operation is completed via a response signal channel of the transactional interface to the host.

11. The method of claim 10, wherein performing, by the memory architecture, an operation in response to receiving the command includes
performing, by the memory architecture, the operation with non-deterministic timing.

12. The method of claim 10, wherein receiving, by the memory architecture, the command from the host via the transactional interface coupled between the memory architecture and the host includes
receiving, by the memory architecture, a read command from the host via the transactional interface coupled between the memory architecture and the host.

13. The method of claim 12, wherein performing, by the memory architecture, the operation in response to receiving the command includes
preparing data by the memory architecture in response to receiving the read command.

14. The method of claim 13, further comprising:
receiving, by the memory architecture, a get command from the host; and
sending, by the memory architecture, the data to the host in response to receiving the get command from the host.

15. The method of claim 10, wherein receiving, by the memory architecture, the command from the host via the transactional interface coupled between the memory architecture and the host includes
receiving, by the memory architecture, a computing command from the host via the transactional interface coupled between the memory architecture and the host.

16. The method of claim 15, wherein performing, by the memory architecture, the operation in response to receiving the command includes
performing, by the memory architecture, a computation operation in response to receiving the computing command.

17. The method of claim 10, wherein receiving, by the memory architecture, the command from the host via the transactional interface coupled between the memory architecture and the host includes
receiving, by the memory architecture, a write command and data to be written, from the host via the transactional interface coupled between the memory architecture and the host.

18. The method of claim 17, wherein performing, by the memory architecture, the operation in response to receiving the command includes
performing, by the memory architecture, a write operation in response to receiving the write command and data to be written.

19. The method of claim 10, further comprising:
receiving, by the memory architecture, metadata and/or Error-Correcting Code (ECC) from the host via the transactional interface coupled between the memory architecture and the host.

20. The method of claim 10, further comprising:
sending, by the memory architecture, a request for permission to the host; and
receiving the permission from the host allowing the memory architecture not to receive command and/or data from the host for a period.

21. A computer-readable storage medium storing computer-readable instructions executable by one or more processors, that when executed by the one or more processors, cause the one or more processors to perform acts comprising:
sending, by a host, a command to a memory architecture via a transactional interface coupled between the memory architecture and the host; and
receiving, by the host, a response signal indicating that an operation is completed, from the memory architecture via a response signal channel of the transactional interface coupled between the memory architecture and the host.

22. The computer-readable storage medium of claim 21, wherein the response signal is received by the host from the memory architecture with non-deterministic timing.

23. The computer-readable storage medium of claim 21, wherein sending, by the host, the command to the memory architecture via the transactional interface coupled between the memory architecture and the host includes
sending, by the host, a read command to the memory architecture via the transactional interface coupled between the memory architecture and the host.

24. The computer-readable storage medium of claim 23, the acts further comprising:
sending, by the host, a get command to the memory architecture; and
receiving, by the host, data from the memory architecture.

25. The computer-readable storage medium of claim 21, wherein sending, by the host, the command to the memory architecture via the transactional interface coupled between the memory architecture and the host includes
sending, by the host, a computing command to the memory architecture via the transactional interface coupled between the memory architecture and the host.

26. The computer-readable storage medium of claim 21, wherein sending, by the host, the command to the memory architecture via the transactional interface coupled between the memory architecture and the host includes
sending, by the host, a write command and data to be written to the memory architecture via the transactional interface coupled between the memory architecture and the host.

27. The computer-readable storage medium of claim 21, the acts further comprising:
sending, by the host, metadata and/or Error-Correcting Code (ECC) to the memory architecture via the transactional interface coupled between the memory architecture and the host.

28. The computer-readable storage medium of claim 21, the acts further comprising:
receiving, by the host, a request for permission from the memory architecture; and
sending, by the host, the permission to the memory architecture in response to receiving the request allowing the memory architecture not to receive command and/or data from the host for a period.
